(19) United States
(12) Patent Application Publication
(10) Pub. No.: US 2025/0222391 A1
(43) Pub. Date: Jul. 10, 2025

(54) GAS TREATMENT DEVICE AND GAS TREATMENT METHOD

(71) Applicant: TOYOBO MC CORPORATION, Osaka-shi, Osaka (JP)

(72) Inventors: Keitaro Kouda, Otsu-shi, Shiga (JP); Toshiaki Hayashi, Osaka-Shi, Osaka (JP); Takemasa Okada, Otsu-shi, Shiga (JP)

(73) Assignee: TOYOBO MC CORPORATION, Osaka-shi, Osaka (JP)

(21) Appl. No.: 18/850,885

(22) PCT Filed: Mar. 23, 2023
(86) PCT No.: PCT/JP2023/011658

§ 371 Date: Sep. 25, 2024

(30) Foreign Application Priority Data
Mar. 30, 2022 (JP) 2022-056989

(51) Int. Cl. B01D 53/04; B01D 53/44

(52) U.S. Cl. CPC B01D 53/0446; B01D 53/44; B01D 2259/4009

(57) ABSTRACT

In a gas treatment device of the present invention, a treatment tank includes a treatment-tank downstream chamber into which a treated gas is introduced, the treated gas being the gas to be treated having been subjected to the adsorption treatment with the adsorbent, and an extraction flow channel for discharging the treated gas, a purge gas supply flow channel for supplying a purge gas with which the treatment-tank downstream chamber is purged, and a purge gas extraction flow channel for discharging the purge gas from the treatment-tank downstream chamber are connected to the treatment-tank downstream chamber.

### TECHNICAL FIELD

The present invention relates to a gas treatment device, and a gas treatment method.

### BACKGROUND ART

Conventionally, a gas treatment device that recovers an organic solvent from a gas to be treated has been known. For example, PTL 1 discloses a gas treatment device that includes: adsorbents that can adsorb and desorb an organic solvent; a plurality of treatment tanks alternately supplied with a gas to be treated containing an organic solvent, and heated steam for desorbing the organic solvent from the adsorbents; and a recovery mechanism that introduces the heated steam into one treatment tank selected from among the plurality of treatment tanks, also introduces the gas to be treated into the remaining treatment tanks, and recovers the organic solvent from a desorbed gas discharged from the treatment tank while the heated steam is supplied.

For example, as described in PTL 2, the adsorbent has a shape in which a layer having a predetermined thickness is wound multiple times in a concentric circle manner, and is fixed to the inside of the treatment tank via a sealing material.

### CITATION LIST

### Patent Literature

PTL 1: Japanese Patent Laying-Open No. 2014-147863

PTL 2: Japanese Patent Laying-Open No. 2001-179029

### SUMMARY OF INVENTION

### Technical Problem

In the gas treatment device described in PTL 1, for the adsorption tank in which a step of desorbing the organic solvent is in operation, an extraction flow channel is closed by an on-off valve between the adsorption tank and the extraction flow channel, thus preventing steam for desorbing the organic solvent from flowing into the extraction flow channel. However, for example, in a case in which the organic solvent to be treated having a high affinity with a sealing material, there is a problem in that the organic solvent infiltrates the sealing material in the step of desorbing the organic solvent, and the organic solvent leaks into a space between the adsorption tank and the on-off valve. However, there is no multi-performance sealing material that satisfies a solvent resistance against all types of organic solvents, a heat resistance against a temperature of 100° C. or more, and the like. Deterioration of the sealing material is also caused by change in fastening force due to vibrations or the like during a prolonged operation.

Owing to such reasons, in an adsorption step after a desorption step, a leaking organic solvent may be contained in an adsorption step outlet gas and discharged to the atmosphere via an extraction flow channel. As a result, the removal rate of the gas treatment device may be degraded.

An object of the present invention, which has been made in view of the problem described above, is to provide a gas treatment device that has an improved organic solvent removal rate.

### Solution to Problem

The present invention provides the following gas treatment device. Specifically, the present invention is a gas treatment device including a treatment tank that includes an adsorbent capable of adsorbing and desorbing an organic solvent, and alternately performs an adsorption treatment of adsorbing the organic solvent with the adsorbent by bringing a gas to be treated containing the organic solvent into contact with the adsorbent, and a desorption treatment of desorbing the organic solvent from the adsorbent with steam, wherein the treatment tank includes a treatment-tank downstream chamber into which a treated gas is introduced, the treated gas being the gas to be treated having been subjected to the adsorption treatment with the adsorbent, and an extraction flow channel for discharging the treated gas, a purge gas supply flow channel for supplying a purge gas with which the treatment-tank downstream chamber is purged, and a purge gas extraction flow channel for discharging the purge gas from the treatment-tank downstream chamber are connected to the treatment-tank downstream chamber.

In addition to the configuration described above, in the present invention, while the steam is supplied to the treatment tank, the purge gas may be supplied to the downstream chamber included in the treatment tank.

In addition to the configuration described above, in the present invention, an end of the purge gas extraction flow channel may be connected to a gas-to-be-treated supply flow channel for supplying the gas to be treated to the treatment tank.

In addition to the configuration described above, in the present invention, at least parts of the extraction flow channel and the purge gas supply flow channel may be shared.

In addition to the configuration described above, in the present invention, an end of the purge gas supply flow channel may be connected to the extraction flow channel.

In addition to the configuration described above, in the present invention, the number of the treatment tanks may be two or more, one or some of the tanks may perform the adsorption treatment, and the remaining tanks may perform the desorption treatment.

In addition to the configuration described above, in the present invention, the number of the treatment tanks may be three or more, one or some of the tanks may perform the desorption treatment, and the remaining treatment tanks may be connected to each other by multi-stage series connection through a coupling flow channel, and may perform the adsorption treatment.

In addition to the configuration described above, in the present invention, at least parts of the coupling flow channel and the purge gas extraction flow channel may be shared.

In addition to the configuration described above, in the present invention, an end of the purge gas extraction flow channel may be connected to the coupling flow channel.

### Advantageous Effects of Invention

According to the present invention, a gas treatment device having an improved organic solvent removal rate can be provided.

### BRIEF DESCRIPTION OF DRAWINGS

FIG. 1 is a diagram schematically showing a configuration of a gas treatment device in a case of including two adsorption tanks according to an embodiment of the present invention.

FIG. 2 is a diagram schematically showing a configuration of a gas treatment device in a case of including three adsorption tanks according to another embodiment of the present invention.

### DESCRIPTION OF EMBODIMENTS

An embodiment of the present invention is described with reference to the drawings. Note that in the following diagrams to be referred to below, identical or corresponding members are assigned the same numerals.

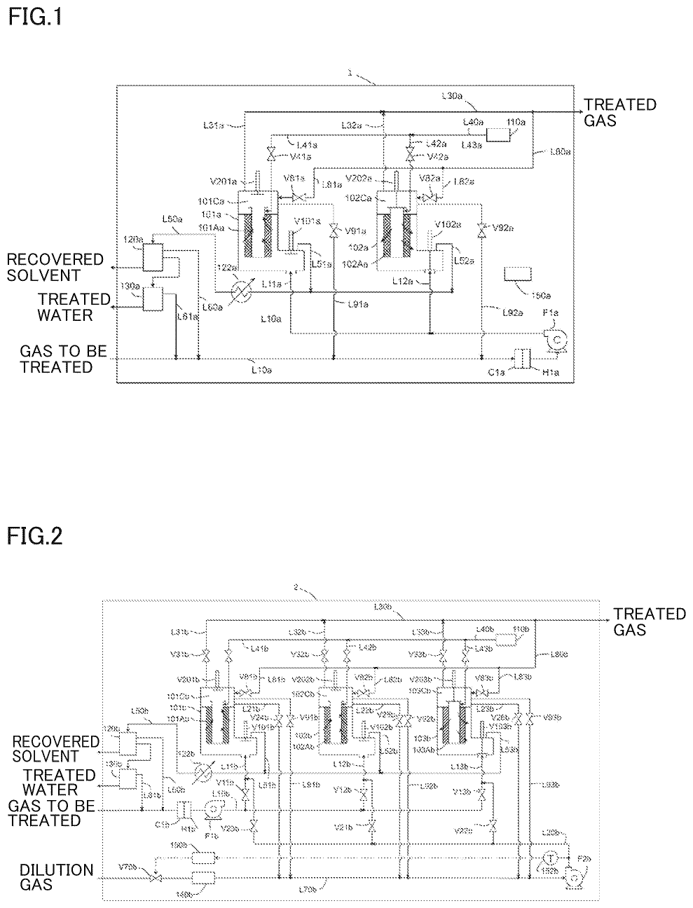

FIG. 1 is a diagram schematically showing a configuration of a gas treatment device 1 according to an embodiment of the present invention. As shown in FIG. 1, gas treatment device 1 is a device that removes and recover an organic solvent from a gas to be treated. Note that the gas to be treated is supplied to gas treatment device 1 from a gas-to-be-treated supply source (not shown) provided out of the system of gas treatment device 1. Gas treatment device 1 includes two treatment tanks 101a and 102a, a gas-to-be-treated supply flow channel L10a, extraction flow channels L31a and L32a, steam supply flow channels L41a and L42a, organic solvent recovery flow channels L51a to L52a, a separator 120a, a resupply flow channel aL60a, and a controller 150a.

In this Description, the organic solvent contained in the gas to be treated indicates methylene chloride, chloroform, carbon tetrachloride, ethylene chloride, trichloroethylene, tetrachloroethylene, O-dichlorobenzene, m-dichlorobenzene, Freon-112, Freon-113, HCFC, HFC, propyl bromide, butyl iodide, methyl acetate, ethyl acetate, propyl acetate, butyl acetate, vinyl acetate, methyl propionate, methyl acrylate, ethyl acrylate, butyl acrylate, methyl methacrylate, diethyl carbonate, ethyl formate, diethyl ether, dipropyl ether, tetrahydrofuran, dibutyl ether, anisole, methanol, ethanol, isopropanol, n-butanol, 2-butanol, isobutanol, t-butanol, allyl alcohol, pentanol, heptanol, ethylene glycol, diethylene glycol, phenol, O-cresol, m-cresol, p-cresol, xylenol, acetone, methyl ethyl ketone, methyl isobutyl ketone, cyclohexanone, holon, acrylonitrile, n-hexane, isohexane, cyclohexane, methylcyclohexane, n-heptane, n-octane, n-nonane, isononane, decane, dodecane, undecane, tetradecane, decalin, benzene, toluene, m-xylene, p-xylene, o-xylene, ethylbenzene, 1,3,5-trimethylbenzene, N-methylpyrrolidone, dimethylformamide, dimethylacetamide, dimethylacetamide, etc. However, these are not limitation.

Treatment tanks 101a and 102a respectively include adsorbents 101Aa and 102Aa that can adsorb an organic solvent and desorb the organic solvent. While granular activated carbon, honeycomb activated carbon, zeolite, activated carbon fibers, etc. can be used as adsorbents 101Aa and 102Aa, it is preferable that activated carbon fibers be used. Note that treatment tanks 101a and 102a shown in FIG. 1 are configured so that one treatment tank is filled with one adsorbent. Alternatively, multiple adsorbents may be included. Treatment tanks 101a and 102a respectively include: dampers V101a and V102a that switch between supplying and supplied states to and from a gas-to-be-treated supply flow port; and dampers V201a and V202a that switch between discharge and non-discharge states for a treated gas having passed through adsorbents 101Aa and 102Aa. Treatment tanks 101a and 102a respectively, internally include treatment-tank downstream chambers 101Ca and 102Ca in which the treated gas with the organic solvent having been removed by adsorbents 101Aa and 102Aa is accumulated until being supplied to extraction flow channels L31a and L32a.

In treatment tanks 101a and 102a, adsorption of the organic solvent with adsorbents 101Aa and 102Aa, and desorption of the organic solvent from adsorbents 101Aa and 102Aa are alternately performed. The details are as follows. That is, an adsorption step of adsorbing the organic solvent with the adsorbent from the gas to be treated supplied from the gas-to-be-treated supply source, in one treatment tank between two treatment tanks 101a and 102a, and a desorption step of desorbing the organic solvent from the adsorbent in the remaining treatment tank are performed. In two treatment tanks 101a and 102a, the adsorption step and the desorption step are repetitively performed. Note that FIG. 1 shows a state in which the adsorption step is performed in adsorption tank 101a, and the desorption step is performed in adsorption tank 102a.

Gas-to-be-treated supply flow channel L10a is a flow channel for supplying the gas to be treated to treatment tanks 101a and 102a. An upstream end of gas-to-be-treated supply flow channel L10a is connected to the gas-to-be-treated supply source. Gas-to-be-treated supply flow channel L10a is provided with an air blower F1a. A part upstream of air blower F1a on gas-to-be-treated supply flow channel L10a is provided with a cooler C1a and a heater H1a for adjusting the temperature and humidity of the gas to be treated that is to flow into treatment tanks 101a and 102a, within desired ranges. Such equipment may be appropriately installed depending on the pressing force, temperature, and humidity of the gas to be treated.

Gas-to-be-treated supply flow channel L10a includes branched flow channels L11a and L12a for supplying the gas to be treated respectively to treatment tanks 101a and 102a. Branched flow channel L11a is provided with an on-off valve V11a. Branched flow channel L12a is provided with an on-off valve V12a.

Extraction flow channels L31a and L33a are flow channels for extracting a treated gas that is the gas to be treated having been subjected to the adsorption treatment in treatment tanks 101a and 102a. Extraction flow channels L31a and L32a are connected to treated gas discharge ports at respective treatment tanks 101a and 102a. First extraction flow channel L31a is provided with an on-off valve V31a. Second extraction flow channel L32a is provided with an on-off valve V32a. Extraction flow channels L31a and L32a include a combined flow channel L30 where they converge. A region beyond combined flow channel L30 is out of the system of gas treatment device 1. The region therebeyond may be the outside air. In a case in which further improvement in organic solvent removal rate is intended, a device (not shown) for treating the organic solvent may be separately connected.

Steam supply flow channels L41a and L42a are flow channels for respectively supplying treatment tanks 101a and 102a with steam for desorbing the organic solvent adsorbed in adsorbents 101Aa and 102Aa, from adsorbents 101Aa and 102Aa. Steam supply flow channels L41a and L42a include a combined flow channel L40a where they converge. Steam is supplied from a steam supplier 110a. Note that steam supplier 110a may be provided in gas treatment device 1, or out of the system of gas treatment device 1.

Steam supply flow channel L41a connects steam supplier 110a and a first treatment tank 101a. Steam supply flow channel L41a is provided with an on-off valve V41a. Steam supply flow channel L42a connects steam supplier 110a and a second treatment tank 102a. Steam supply flow channel L42a is provided with an on-off valve V42a.

Organic solvent recovery flow channels L51a and L52a are flow channels for recovering steam (desorbed gas) containing the organic solvent desorbed from adsorbents 101Aa and 102Aa. Organic solvent recovery flow channels L51a and L52a are respectively connected to treatment tanks 101a and 102a. Organic solvent recovery flow channels L51a and L52a include a combined flow channel L50a where they converge. Combined flow channel L50a is provided with a condenser 122a. Condenser 122a condenses the desorbed gas flowing through combined flow channel L50a, by cooling the desorbed gas, and discharges the condensate (a mixture of moisture generated by condensing the desorbed gas, and the organic solvent).

Separator 120a is provided at a downstream end of combined flow channel L50a. The condensate flows into separator 120a. Subsequently, in separator 120a, the condensate undergoes phase separation into the liquid-phase separated drainage (condensate of steam sometimes containing a small amount of organic solvent), and the liquid-phase recovered solvent, and the recovered solvent is extracted to the outside of the system of gas treatment device 1. Note that a space (vent gas) in which the gas-phase organic solvent resides is formed in an upper part of separator 120a.

Resupply flow channel L60a is a flow channel that connects separator 120a and gas-to-be-treated supply flow channel L10a. An upstream end of resupply flow channel L60a is connected to the upper part of separator 120a (the part of separator 120a in which the gas-phase organic solvent resides). A downstream end of resupply flow channel L60a is connected to a part of gas-to-be-treated supply flow channel L10a that is upstream of cooler C1a. Accordingly, it is preferable that the gas-phase organic solvent residing in separator 120a be resupplied to treatment tanks 101a and 102a through resupply flow channel L60a and gas-to-be-treated supply flow channel L10a.

A drainage treatment facility 130a is a facility that removes the organic solvent contained in the separated drainage. The liquid-phase separated drainage of separator 120a is supplied, the organic solvent is removed from the separated drainage, and the treated water is discharged to the outside of the system of gas treatment device 1. Specific drainage treatment facility 130a may be an aeration facility that applies an aeration treatment to the separated drainage, and vaporizes the organic solvent contained in the separated drainage accordingly, thus achieving separation between an aeration gas containing the organic solvent, and treated water. Note that the aeration gas is introduced to the part of gas-to-be-treated supply flow channel L10a that is upstream of cooler C1a via an aeration gas supply flow channel L61a. Although not shown, the aeration gas supply flow channel may be provided with dehumidification means for the sake of removing moisture from the aeration gas.

Purge gas supply flow channels L81a and L82a are flow channels for supplying the treated gas flowing through combined flow channel L30a, as a purge gas, into treatment-tank downstream chambers 101Ca and 103Ca. Purge gas supply flow channels L81a and L82a include a combined flow channel L80a where they converge. Purge gas supply flow channel L81a is connected to adsorption tank 101a, and includes an on-off valve V81a. Purge gas supply flow channel L82a is connected to adsorption tank 102a, and includes an on-off valve V82a. Note that the outside air, instrument air, nitrogen gas, argon gas or the like may be separately supplied, as the purge gas, from the outside of organic solvent treatment device 1.

Purge gas extraction flow channels L91a and L92 are flow channels for returning the purge gas with which the insides of treatment-tank downstream chambers 101Ca and 102Ca have been purged, to the upstream side of air blower F1a on gas-to-be-treated supply flow channel L10a.

Purge gas extraction flow channel L91a is connected to adsorption tank 101a, and includes an on-off valve V91a. Purge gas extraction flow channel L92a is connected to adsorption tank 102a, and includes an on-off valve V92a. Note that the purge gas may be discharged to the outside of the system of organic solvent treatment device 1. Note that in the case of discharge to the outside of the system of organic solvent treatment device 1, the organic solvent contained in the purge gas is required to be treated by providing another organic solvent treatment device.

Controller 150a controls opening and closing of on-off valves V41a, V42a, V81a, V82a, V91a, and V92a, and on-off dampers V101a, V102a, V201a, and V202a so that treatment tanks 101a and 102a can be used in the order of the adsorption step and the desorption step as described above.

Next, the operation of gas treatment device 1 is described. Here, referring to FIG. 1, an example of the operation of gas treatment device 1 is described. Referring to FIG. 1, description is made assuming a state in which the adsorption step is performed in first treatment tank 101a, and the desorption step is performed in second treatment tank 102a.

Note that in each treatment tank, the treatment is repeated in the order of the adsorption step→the desorption step→the adsorption step . . . .

As to each of the on-off valves and the on-off dampers, on-off valves V42a, V82a, and V92a, and on-off dampers V101a, and V201a are opened, and on-off valves V41a, V81a, and V91a, and on-off dampers V102a, and V202a are closed.

From the gas-to-be-treated supply source, through gas-to-be-treated supply flow channel L10a and branched flow channel L11a, the gas to be treated is supplied to first treatment tank 101a, and the organic solvent contained in the gas to be treated is adsorbed in adsorbent 101Aa of first treatment tank 101a (adsorption step). Subsequently, the treated gas is discharged to the outside of the system of gas treatment device 1 through extraction flow channel L31a and combined flow channel L30a.

On the other hand, steam is supplied to second treatment tank 102a from steam supplier 110a through third steam supply flow channel L42a, thereby desorbing the organic solvent from adsorbent 102Aa (desorption step). The steam containing organic solvent desorbed from adsorbent 102Aa passes through organic solvent recovery flow channel L52a, is condensed by condenser 122a, and subsequently flows into separator 120a. The recovered solvent phase-separated by separator 120a is extracted to the outside of the system of gas treatment device 1. The vent gas residing in separator 120a is returned to gas-to-be-treated supply flow channel L10a through resupply flow channel L60a. The separated drainage is treated by drainage treatment facility 130a. The treated water is extracted to the outside of the system of gas treatment device 1. The aeration gas is returned to gas-to-be-treated supply flow channel L10a through aeration gas supply flow channel L61a.

In the desorption step, the treated gas is aspirated as the purge gas by an air blower F2a through combined flow channel L80a, purge gas supply flow channel L82a, treatment-tank downstream chamber 102Ca, and purge gas extraction flow channel L92a, and is thus sent to combined flow channel L10a. By using treated gas as the purge gas, the air flow rate of clean gas that is discharged as a clean gas can be smaller compared to a case of supplying an outside air or the like as the purge gas from the outside of the system of gas treatment device 1. Accordingly, in a case in which the gas treatment device can be more reduced in size, or the removal rate is intended to be improved by further connecting another gas treatment device subsequent to the gas treatment device, the treatment air flow rate of the subsequent gas treatment device can be reduced, and reduction in size can be achieved.

An air blower for blowing the purge gas may be separately provided. However, in a case of using aspiration by air blower F1a, the initial cost of gas treatment device 1 can be reduced.

As described above, the purge gas is in a state of being always supplied to treatment-tank downstream chambers 101Ca and 102Ca during the desorption step. In case the desorbed steam containing the organic solvent leaks into the treatment-tank downstream chamber, the desorbed steam containing the organic solvent is pushed by the purge gas and sent to combined flow channel L10a. Accordingly, the desorbed steam containing the organic solvent is not accumulated in treatment-tank downstream chambers 101Ca and 102Ca. Accordingly, when the desorption step is switched to the adsorption step, the desorbed steam containing the organic solvent in the treatment-tank downstream chamber is prevented from being discharged to the outside of the system of gas treatment device 1 through extraction flow channels L31a and L32a. Consequently, this gas treatment device 1 can improve the organic solvent removal rate.

Next, a gas treatment device of another embodiment of the present invention is described.

FIG. 2 is a diagram schematically showing a configuration of a gas treatment device 2 according to the other embodiment of the present invention. As shown in FIG. 2, gas treatment device 2 is a device that removes and recovers an organic solvent from a gas to be treated. Note that the gas to be treated is supplied to organic solvent device 2 from a gas-to-be-treated supply source (not shown) provided out of the system of organic solvent device 2. Organic solvent device 2 includes three treatment tanks 101b to 103b, a gas-to-be-treated supply flow channel L10b, coupling flow channels L21b to L23b, extraction flow channels L31b to L33b, steam supply flow channels L41b to L43b, organic solvent recovery flow channels L51b to L53b, a separator 120b, a resupply flow channel L60b, a dilution gas supply flow channel L70b, a heater 140b, an on-off valve v70b, and a controller 150b. Note that FIG. 2 shows gas treatment device 2 provided with the three treatment tanks. Alternatively, the number of adsorption tanks may be four or more.

Treatment tanks 101b to 103b respectively include adsorbents 101Ab to 103Ab that can adsorb an organic solvent and desorb the organic solvent. While granular activated carbon, honeycomb activated carbon, zeolite, activated carbon fibers, etc. can be used as adsorbents 101Ab to 103Ab, it is preferable that activated carbon fibers be used. Note that treatment tanks shown in FIG. 2 are configured so that one treatment tank is filled with one adsorbent. Alternatively, multiple adsorbents may be included. Treatment tanks 101b to 103b respectively include: dampers V101b to V103b that switch between supply and non-supply to a gas-to-be-treated supply port; and dampers V201b to V203b that switch between discharge and non-discharge of the treated gas having passed through adsorbents 101Ab to 103Ab. Treatment tanks 101b to 103b respectively, internally include treatment-tank downstream chambers 101Cb to 103Cb in which the treated gas from which the organic solvent have been removed by the adsorbents 101Ab to 103Ab is accumulated until being supplied to extraction flow channels L31b to L33b.

In treatment tanks 101b to 103b, adsorption of the organic solvent with adsorbents 101Ab to 103Ab, and desorption of the organic solvent from adsorbents 101Ab to 103Ab are alternately performed. The details are as follows. That is, in one treatment tank among three treatment tanks 101b to 103b, a first adsorption step of adsorbing the organic solvent with the adsorbent from the gas to be treated supplied from the gas-to-be-treated supply source is performed, in another treatment tanks among three treatment tanks 101b to 103b, a second adsorption step of adsorbing the organic solvent with the adsorbent from the gas to be treated (first adsorption step outlet gas) having been treated in the treatment tank used in the first adsorption step, and discharging the treated gas is performed, and meanwhile, in the remaining one adsorption tank, the desorption step of desorbing the organic solvent from the adsorbent is performed. In each of treatment tanks 101b to 103b, the desorption step, the second adsorption step, the first adsorption step, and the desorption step are repetitively performed in this order. Note that referring to FIG. 2, the first adsorption step is performed in first treatment tank 101b, the second adsorption step is performed in second adsorption tank 102b, and the desorption step is performed in third adsorption tank 103b.

Gas-to-be-treated supply flow channel L10b is a flow channel for supplying the gas to be treated to treatment tanks 101b to 103b. An upstream end of gas-to-be-treated supply flow channel L10b is connected to the gas-to-be-treated supply source. Gas-to-be-treated supply flow channel L10b is provided with an air blower F1b. A part upstream of air blower F1b on gas-to-be-treated supply flow channel L10b is provided with a cooler C1b and a heater H1b for adjusting the temperature and humidity of the gas to be treated that is to flow into treatment tanks 101b to 103b, within desired ranges. Such equipment may be appropriately installed depending on the pressing force, temperature, and humidity of the gas to be treated.

Gas-to-be-treated supply flow channel L10b includes branched flow channels L11b to L13b for supplying the gas to be treated respectively to treatment tanks 101b to 103b. Branched flow channel L11b is provided with an on-off valve V11b. Branched flow channel L12b is provided with an on-off valve L12b. Branched flow channel L13b is provided with an on-off valve V13b.

Coupling flow channels L21b to L23b each couple one treatment tank to another treatment tank so that the gas to be treated from which the organic solvent has been adsorbed with the adsorbent of one treatment tank (the treatment tank used for the first adsorption step) among three treatment tanks 101b to 103b can be introduced to the gas-to-be-treated supply port at another treatment tank (the treatment tank used for the second adsorption step) different from the one treatment tank among three treatment tanks 101b to 103b. Specifically, first coupling flow channel L21b couples the treated gas discharge port at first treatment tank 101b to the gas-to-be-treated supply port at second treatment tank 102b. Second coupling flow channel L22b couples the treated gas discharge port at second treatment tank 102b to the gas-to-be-treated supply port at third treatment tank 103b. Third coupling flow channel L23b couples the treated gas discharge port at third treatment tank 103b to the gas-to-be-treated supply port at first treatment tank 101b.

Communicating flow channels L21b to L23b respectively include on-off valves V24b to V26b that switch between supply and non-supply in order to selectively supply the treated gas from the adsorption tank used in the first adsorption step to the adsorption tank used in the second adsorption step. Coupling flow channel L21b is provided with an on-off valve V24b. Coupling flow channel L22b is provided with an on-off valve V25b. Coupling flow channel L23b is provided with an on-off valve V26b.

Coupling flow channels L21b to L23b include a combined flow channel L20b where they converge. Combined flow channel L20b is provided with an air blower F2b. At a part on first coupling flow channel L21b rebranched from combined flow channel L20b, an on-off valve V21b is provided. At a part on second coupling flow channel L22b rebranched from combined flow channel L20b, an on-off valve V22b is provided. At a part on third coupling flow channel L23b rebranched from combined flow channel L20b, an on-off valve V23b is provided.

Extraction flow channels L31b to L33b are flow channels for extracting a first treated gas that is the gas to be treated having been subjected to the adsorption treatment in treatment tanks 101b to 103b. Extraction flow channels L31b to L33b are connected to treated gas discharge ports at respective treatment tanks 101b to 103b. First extraction flow channel L31b is provided with an on-off valve V31b. Second extraction flow channel L32 is provided with an on-off valve V32b. Third extraction flow channel L33b is provided with an on-off valve V33b. Extraction flow channels L31b to L33b include a combined flow channel L30b where they converge. Note that use of a three-way valve or the like may allow on-off valve V31b and on-off valve V24b to be achieved as one valve using a three-way valve or the like and control the flow channel; this may apply to on-off valve V32b and on-off valve V25b, and to on-off valve V33b and on-off valve V26b. A region beyond combined flow channel L30b is out of the system of gas treatment device 2. The region therebeyond may be the outside air. In a case in which further improvement in organic solvent removal rate is intended, a device (not shown) for treating the organic solvent may be separately connected.

Steam supply flow channels L41b to L43b are flow channels for respectively supplying treatment tanks 101b to 103b with steam for desorbing the organic solvent adsorbed in adsorbents 101Ab to 103Ab, from adsorbents 101Ab to 103Ab.

Steam is supplied from a steam supplier 110b. Note that steam supplier 110b may be provided in gas treatment device 2, or out of the system of gas treatment device 2.

First steam supply flow channel L41b connects steam supplier 110b and a first treatment tank 101b. First steam supply flow channel L41b is provided with an on-off valve V41b. Second steam supply flow channel L42b connects steam supplier 110b and a second treatment tank 102b. Second steam supply flow channel L42b is provided with an on-off valve V42b. Third steam supply flow channel L43b connects steam supplier 110b and third treatment tank 103b. Third steam supply flow channel L43 is provided with an on-off valve V43.

Organic solvent recovery flow channels L51b to L53b are flow channels for recovering steam (desorbed gas) containing the organic solvent desorbed from adsorbents 101Ab to 103Ab. Organic solvent recovery flow channels L51b to L53b are respectively connected to treatment tanks 101b to 103b. Organic solvent recovery flow channels L51b to L53b include a combined flow channel L50b where they converge. Combined flow channel L50b is provided with a condenser 122b.

Condenser 122b condenses the desorbed gas by cooling the desorbed gas flowing through combined flow channel L50b, and discharges the condensate (a mixture of moisture generated by condensing the desorbed gas, and the organic solvent).

Separator 120b is provided at a downstream end of combined flow channel L50b. The condensate flows into separator 120b. Subsequently, in separator 120b, the condensate undergoes phase separation into the liquid-phase separated drainage (condensate of steam sometimes containing a small amount of organic solvent), and the liquid-phase recovered solvent, and the recovered solvent is extracted to the outside of the system of gas treatment device 2. Note that a space (vent gas) in which the gas-phase organic solvent resides is formed in an upper part of separator 120b.

Resupply flow channel L60b is a flow channel that connects separator 120b and gas-to-be-treated supply flow channel L10b. An upstream end of resupply flow channel L60b is connected to the upper part of separator 120b (the part of separator 120b in which the gas-phase organic solvent resides). A downstream end of resupply flow channel L60b is connected to a part of gas-to-be-treated supply flow channel L10b that is upstream of cooler C1b. Accordingly, it is preferable that the gas-phase organic solvent residing in separator 120b be resupplied to treatment tanks 101b to 103b through resupply flow channel L60b and gas-to-be-treated supply flow channel L10b.

A drainage treatment facility 130b is a facility that removes the organic solvent contained in the separated drainage. The liquid-phase separated drainage of separator 120b is supplied, the organic solvent is removed from the separated drainage, and the treated water is discharged to the outside of the system of gas treatment device 2. Specific drainage treatment facility 130b may be an aeration facility that applies an aeration treatment to the separated drainage, and vaporizes the organic solvent contained in the separated drainage accordingly, thus achieving separation between an aeration gas containing the organic solvent, and treated water. Note that the aeration gas is introduced to the part of gas-to-be-treated supply flow channel L10b that is upstream of cooler C1b via an aeration gas supply flow channel L61b. Although not shown, the aeration gas supply flow channel may be provided with dehumidification means for the sake of removing moisture from the aeration gas.

Dilution gas supply flow channel L70b is a flow channel for supplying coupling flow channels L21b to L23b with a dilution gas for promoting drying first adsorbents 101Ab to 103Ab after the desorption step. The dilution gas is made up of a gas that contains at least one of the outside air, instrument air, nitrogen gas, and argon gas.

Heater 140b is provided on dilution gas supply flow channel L70b. Heater 140b heats the dilution gas so that the temperature of the dilution gas can be higher than the temperature (about 40° C.) of the gas to be treated flowing through coupling flow channels L21b to L23b.

On-off valve V70b is provided on dilution gas supply flow channel L70b. On-off valve V70b can adjust the opening degree.

Purge gas supply flow channel L81b to L83b are flow channels for supplying the treated gas flowing through combined flow channel L30b, as a purge gas, into treatment-tank downstream chambers 101Cb to 103Cb. Purge gas supply flow channel L81b is connected to adsorption tank 101b, and includes an on-off valve V81b. Purge gas supply flow channel L82b is connected to adsorption tank 102b, and includes an on-off valve V82b. Purge gas supply flow channel L83b is connected to adsorption tank 103b, and includes an on-off valve V83b. Note that the outside air, instrument air, nitrogen gas, argon gas or the like may be separately supplied, as the purge gas, from the outside of organic solvent treatment device 2.

Purge gas extraction flow channels L91b to L93b are flow channels for returning the purge gas with which the insides of treatment-tank downstream chambers 101Cb to 103Cb have been purged, to the upstream side of air blower F2b on coupling flow channel L20b. Purge gas extraction flow channel L91b is connected to adsorption tank 101b, and includes an on-off valve V91b. Purge gas extraction flow channel L92b is connected to adsorption tank 102b, and includes an on-off valve V92b. Purge gas extraction flow channel L93b is connected to adsorption tank 103b, and includes an on-off valve V93b. Note that the purge gas used for purging may be returned to the upstream side of air blower F1b on gas-to-be-treated supply flow channel L10b, or discharged to the outside of the system of organic solvent treatment device 2. Note that in the case of discharge to the outside of the system of organic solvent treatment device 2, the organic solvent contained in the purge gas is required to be treated by providing another organic solvent treatment device.

Purge gas supply flow channels L91b to L93b may be used in combination with coupling flow channels L21b to L23b for the sake of reducing the size of the device.

Controller 150b controls the opening degree of on-off valve v70b. Specifically, controller 150b controls the opening degree of on-off valve V70 so that the temperature of the gas to be treated flowing into the adsorption tank used in the second adsorption step (the treatment tank disposed downstream of the flow of the gas to be treated between two treatment tanks 101b to 103b coupled by coupling flow channels L21b to L23b) can be maintained in a predetermined region (e.g., 40° C. to 80° C.).

Note that the temperature of the mixed gas flowing into the adsorption tank used in the second adsorption step is detected by a temperature sensor 152b. Temperature sensor 152b is provided on combined flow channel L20b.

Controller 150b controls opening and closing of on-off valves V11b to V13b, V21b to V26b, V31b to V33b, V41b to V43b, V81b to V83b, and V91b to V93b, and on-off dampers V101b to V103b, and V201b to V203b so that treatment tanks 101b to 103b can be used in the order of the second adsorption step, the first adsorption step, and the desorption step as described above.

Next, the operation of gas treatment device 2 is described. Here, referring to FIG. 2, an example of the operation of gas treatment device 2 is described. Referring to FIG. 2, description is made assuming a state in which the first adsorption step is performed in first treatment tank 101b, the second adsorption step is performed in second treatment tank 102b, and the desorption step is performed in third treatment tank 103b.

Note that in each treatment tank, the treatment is repeated in the order of the first adsorption step→the desorption step→the second adsorption step→the first adsorption step . . . .

At the on-off valves and the on-off dampers, on-off valves V11b, V21b, V24b, V32b, V43b, V83b, and V93b, and on-off dampers V101b, V102b, V201b, and V202b are open, and on-off valves V12b, V13b, V22b, V23b, V25b, V26b, V81b, V82b, V91b, V92b, V31b, V33b, V41b, and V42b, and on-off dampers V103b and V203b are closed.

From the gas-to-be-treated supply source, through gas-to-be-treated supply flow channel L10b and branched flow channel L11b, the gas to be treated is supplied to first treatment tank 101b, and the organic solvent contained in the gas to be treated is adsorbed in adsorbent 101Ab of first treatment tank 101b (first adsorption step). Subsequently, the gas to be treated is supplied to second treatment tank 102b through first coupling flow channel L21b, and the organic solvent contained in the gas supplied to an adsorbent 102Ab of second treatment tank 102b is further adsorbed (second adsorption step). The treated gas discharged from the second treatment tank is discharged to the outside of the system of gas treatment device 2 through combined flow channel L30b. In the second adsorption step (specifically at the initial stage thereof) in second treatment tank 102b, second adsorbent 102Ab is dried by the supplied gas. Since the second adsorption step is executed after the desorption step using steam, adsorbent 102Ab contains steam, and requires desiccation for improving the adsorption performance. The desiccation is described later again. Note that even a system where the desiccation performed in the second adsorption step is separated as a drying step, that is, a system where each treatment tank performs treatment in the order of the first adsorption step→the desorption step→the drying step→the second adsorption step→the first adsorption step→ . . . , can be supported by this system.

On the other hand, steam is supplied to third treatment tank 103b from steam supplier 110b through third steam supply flow channel L43b, thereby desorbing the organic solvent from adsorbent 103Ab (desorption step). The steam containing organic solvent desorbed from adsorbent 103Ab passes through organic solvent recovery flow channel L53b, is condensed by condenser 122b, and subsequently flows into separator 120b. The recovered solvent phase-separated by separator 120b is extracted to the outside of the system of gas treatment device 2. The vent gas residing in separator 120b is returned to gas-to-be-treated supply flow channel L10b through resupply flow channel L60b. The separated drainage is treated by drainage treatment facility 130b. The treated water is extracted to the outside of the system of gas treatment device 2. The aeration gas is returned to gas-to-be-treated supply flow channel L10b through aeration gas supply flow channel L61b.

In the desorption step, the treated gas is aspirated as the purge gas by an air blower F2b through combined flow channel L80b, purge gas supply flow channel L83b, treatment-tank downstream chamber 103Cb, and purge gas extraction flow channel L93b, and is thus sent to combined flow channel L20b. By using treated gas as the purge gas, the air flow rate of clean gas that is discharged as a clean gas can be smaller compared to a case of supplying the outside air or the like as the purge gas from the outside of the system of gas treatment device. Accordingly, in a case in which the gas treatment device can be more reduced in size, or the removal rate is intended to be improved by further connecting another gas treatment device subsequent to the gas treatment device, the treatment air flow rate of the subsequent gas treatment device can be reduced, and reduction in size can be achieved.

An air blower for blowing the purge gas may be separately provided. However, in a case of using aspiration by air blower F2b, the initial cost of gas treatment device 2 can be reduced.

As described above, the purge gas is in a state of being always supplied to treatment-tank downstream chambers 101Cb to 103Cb in the desorption step. In case the desorbed steam containing the organic solvent leaks into the treatment-tank downstream chamber, the desorbed steam containing the organic solvent is pushed by the purge gas and sent to combined flow channel L20b. Accordingly, the desorbed steam containing the organic solvent is not accumulated in treatment-tank downstream chambers 101Cb to 103Cb. Accordingly, when the desorption step is switched to the second adsorption step, the desorbed steam containing the organic solvent in the treatment-tank downstream chamber is prevented from being discharged to gas treatment device 2 through extraction flow channels L31b to L33b. Consequently, this gas treatment device 2 can improve the organic solvent removal rate.

For example, gas treatment device 2 may include four or more treatment tanks. In this case, the desorption step is performed in one treatment tank. Meanwhile, multi-stage adsorption steps are performed in the remaining three or more treatment tanks coupled in series by coupling flow channels.

In gas treatment device 2, adsorbents 101Ab to 103Ab cannot achieve a sufficient adsorption performance in a state of containing moisture. Consequently, both the first adsorption step and the second adsorption step require sufficient desiccation of first adsorbents 101Ab to 103Ab. Since the desorption step uses moisture, first adsorbents 101Ab to 103Ab after completion of desorption contains moisture due to steam. Consequently, desiccation is particularly required for adsorbents 101Ab to 103Ab with which the second adsorption step is executed after completion of desorption.

In the second adsorption step, desiccation is performed through aeration with the gas discharged in the first adsorption step, simultaneously with adsorption. However, sufficient desiccation is sometimes unachieved. Accordingly, this gas treatment device 2 supplies and uses the dilution gas as an auxiliary gas for desiccation. To sufficiently dry adsorbents 101Ab to 103Ab, heater 140b described above is also used in some cases. If sufficient desiccation can be achieved with the first adsorption step outlet gas and the purge gas, the dilution gas is not required to be added.

Examples using the aforementioned gas treatment devices are described below.

### Example 1

The following treatment was executed using aforementioned gas treatment device 1 shown in FIG. 1. A gas containing an organic solvent as a gas to be treated was a gas to be treated that contains 5000 ppm of methylene chloride at 25° C. with an air flow rate of 4.0 Nm³/min. Round ducts were used as the respective ducts for connection. Activated carbon fibers were used as the adsorbents.

First, the gas to be treated was supplied to gas-to-be-treated supply flow channel L10a of gas treatment device 1. Blowing at an air flow rate of 8.0 Nm³/min was performed by air blower F1a to first treatment tank 101a in the adsorption step. The gas treated in first treatment tank 101 was discharged as a treated gas to the outside of the system of gas treatment device 1.

While first treatment tank 101a was performing the adsorption step, second treatment tank 102a introduced a steam and performed the desorption step. At this time, 0.5 Nm³/min of the treated gas on L30a was supplied as the purge gas through L80a and L82a into treatment-tank downstream chamber 102Ca residing in second treatment tank 102b. The purge gas was introduced into gas-to-be-treated supply flow channel L10a.

At the time when the methylene chloride concentration of the adsorption step outlet gas discharged from first treatment tank 101a reaches 50 ppm, the step was switched. The treatment was executed until first adsorption tanks 101a and 102a repeated the adsorption step and the desorption step 2100 times each.

The methylene chloride concentration of the treated gas at the time when the adsorption step and the desorption step were performed 2100 times was on average at 7 ppm.

### Example 2

The following treatment was executed using aforementioned gas treatment device 2 shown in FIG. 2. A gas containing an organic solvent as a gas to be treated was a gas to be treated that contains 27000 ppm of methylene chloride at 25° C. with an air flow rate of 2.2 Nm³/min. Round ducts were used as the respective ducts for connection. Activated carbon fibers were used as the adsorbents.

First, the gas to be treated was supplied to gas-to-be-treated supply flow channel L10b of gas treatment device 2. Blowing at an air flow rate of 2.2 Nm³/min was performed by air blower F1b to first treatment tank 101b in the first adsorption step. Subsequently, the first adsorption step outlet gas discharged from first treatment tank 101b was blown by air blower F2b as a second adsorption step inlet gas to second treatment tank 102b in the second adsorption step. At this time, the second adsorption step was adjusted with the dilution gas and the purge gas to 2.9 Nm³/min and 50° C. The gas treated in second treatment tank 102 was discharged as a treated gas to the outside of the system of gas treatment device 2.

While first treatment tank 101b was performing the first adsorption step and second treatment tank 102b was performing the second adsorption step, third treatment tank 103b introduced a steam for desorption and performed the desorption step. At this time, 0.5 Nm³/min of the treated gas on L30b was supplied as the purge gas through L80b and L83b into treatment-tank downstream chamber 103Cb residing in third treatment tank 103b.

At the time when the methylene chloride concentration of the first adsorption step outlet gas discharged from first treatment tank 101b reaches 1300 ppm, the step was switched. The treatment was executed until first adsorption tanks 101b, 102b, and 103b repeated the first adsorption step, the desorption step, and the second adsorption step 2100 times each.

The methylene chloride concentration of the treated gas at the time when the first adsorption step, the desorption step, and the second adsorption step were performed 2100 times was on average at 8 ppm.

### Comparative Example 1

Similar to Example 1, the gas to be treated identical to that in Example 1 was treated by gas treatment device 1. Note that the inside of the treatment-tank downstream chamber in the treatment tank in the desorption step was not purged, and purge gas supply flow channels L81a and L82a, and the purge gas extraction flow channel were closed. As a result, the methylene chloride concentration of the treated gas was on average at 36 ppm.

### Comparative Example 2

Similar to Example 2, the gas to be treated identical to that in Example 2 was treated by gas treatment device 2. Note that the inside of the treatment-tank downstream chamber in the treatment tank in the desorption step was not purged, and purge gas supply flow channels L81b to L83b, and the purge gas extraction flow channel were closed. As a result, the methylene chloride concentration of the treated gas was on average at 30 ppm.

As can be seen by the above description, unlike Comparative Examples, Examples include flow channels for executing purging. Accordingly, the removal performance of the gas treatment device can be improved by executing purging.

Note that all of the embodiment and Examples disclosed above are only examples, and are not restrictive. Embodiments and Examples achieved by appropriately combining the configurations disclosed in Embodiment and each Example are also encompassed by the present invention. That is, the technical scope of the present invention are effective by the claims, and encompasses content equivalent to the description in the claims, and all changes, modifications, and replacements and the like in the scope.

### INDUSTRIAL APPLICABILITY

According to the gas treatment device of the present invention, the organic solvent removal rate can be improved, which is industrially useful.

### REFERENCE SIGNS LIST

1 Gas treatment device
101a First treatment tank
101Aa First adsorbent
102a Second treatment tank,
102Aa First adsorbent
101Ca, 102Ca Treatment-tank downstream chamber
110a Steam supplier
120a Separator
130a Drainage treatment facility
150a Controller,
L10a Gas-to-be-treated supply flow channel
L31a, L32a Extraction flow channel
L41a, L42a Steam supply flow channel
L51a, L52a Organic solvent recovery flow channel
L60a Resupply flow channel
L81a, L82a Purge gas supply flow channel
L91a, L92 Purge gas extraction flow channel
V41b, V42a; V81a, V82a; V91a, V92a On-off valve
V101a, 102a; V201a, 202a On-off damper
F1a Air blower (gas-to-be-treated supplier)
2 Gas treatment device
101b First treatment tank
101Ab First adsorbent
102b Second treatment tank
102Ab First adsorbent
103b Third treatment tank
103 Ab First adsorbent,
101Cb to 103Cb Treatment-tank downstream chamber
110b Steam supplier
120b Separator
130b Drainage treatment facility
140b Heater
150b Controller
152b Temperature sensor
L10b Gas-to-be-treated supply flow channel
L21b to L23b Coupling flow channel
L31b to L33b Extraction flow channel
L41b, L42b Steam supply flow channel
L51b to L53b Organic solvent recovery flow channel
L60b Resupply flow channel
L70b Dilution gas supply flow channel
L81a to L82b Purge gas supply flow channel
L91b to L93b Purge gas extraction flow channel
V11b to V13b, V21b to V26b, V31b to V33b, V41b to V43b On-off valve
V70b, V81b to V83b, V91b to V93b On-off valve
V101b to V103b, V201b to V203b On-off damper
F1b Air blower (gas-to-be-treated supplier)

1. A gas treatment device comprising a treatment tank that includes an adsorbent capable of adsorbing and desorbing an organic solvent, and alternately performs an adsorption treatment of adsorbing the organic solvent with the adsorbent by bringing a gas to be treated containing the organic solvent into contact with the adsorbent, and a desorption treatment of desorbing the organic solvent from the adsorbent with steam,
wherein the treatment tank includes a treatment-tank downstream chamber into which a treated gas is introduced, the treated gas being the gas to be treated having been subjected to the adsorption treatment with the adsorbent, and
an extraction flow channel for discharging the treated gas, a purge gas supply flow channel for supplying a purge gas with which the treatment-tank downstream chamber is purged, and a purge gas extraction flow channel for discharging the purge gas from the treatment-tank downstream chamber are connected to the treatment-tank downstream chamber.

2. The gas treatment device according to claim 1, wherein while the steam is supplied to the treatment tank, the purge gas is supplied to the downstream chamber included in the treatment tank.

3. The gas treatment device according to claim 1, wherein an end of the purge gas extraction flow channel is connected to a gas-to-be-treated supply flow channel for supplying the gas to be treated to the treatment tank.

4. The gas treatment device according to claim 1, wherein at least parts of the extraction flow channel and the purge gas supply flow channel are shared.

5. The gas treatment device according to claim 1, wherein an end of the purge gas supply flow channel is connected to the extraction flow channel.

6. The gas treatment device according to claim 1, wherein the number of the treatment tanks is two or more, one or some of the tanks perform the adsorption treatment, and the remaining tanks perform the desorption treatment.

7. The gas treatment device according to claim 1, the number of the treatment tanks is three or more, one or some of the tanks perform the desorption treatment, and the remaining treatment tanks are connected to each other by multi-stage series connection through a coupling flow channel, and perform the adsorption treatment.

8. The gas treatment device according to claim 7, wherein at least parts of the coupling flow channel and the purge gas extraction flow channel are shared.

9. The gas treatment device according to claim 7, wherein an end of the purge gas extraction flow channel is connected to the coupling flow channel.
